(19) United States
(12) Patent Application Publication
(10) Pub. No.: US 2012/0114198 A1
(43) Pub. Date: May 10, 2012

(54) FACIAL IMAGE GENDER IDENTIFICATION SYSTEM AND METHOD THEREOF

(76) Inventors: Ting-Ting YANG, Yuanlin -Township (TW); Yu-Ting Lin, Chiayi City (TW); Chun-Yen Cheng, Keelung City (TW); Shih-Chun Chou, Taipei City (TW)

(21) Appl. No.: 12/966,581

(22) Filed: Dec. 13, 2010

(30) Foreign Application Priority Data
Nov. 8, 2010 (TW) 99138294

(51) Int. Cl. G06K 9/00

(52) U.S. Cl. 382/118

(57) ABSTRACT

A facial image gender identification system is provided. The system includes a face database, an image capturing unit, a gender identification data generating unit, and a gender identification unit. The face database is for storing gender characteristic values and gender data corresponding to each of a plurality of training facial images respectively. The image capturing unit is for capturing at least one facial image. The gender identification data generating unit, coupled to the image capturing unit and the face database, is for receiving the facial image from the image capturing unit and calculating global feature values and local feature values of the facial image. The gender identification unit, coupled to the gender identification data generating unit and the face database, is for determining a gender identification result according the global feature values and local feature values, and the gender characteristic values and gender data stored in the face database.

### CROSS REFERENCE TO RELATED APPLICATIONS

This Application claims priority of Taiwan Application No. 99138294, filed on Nov. 8, 2010, the entirety of which is incorporated by reference herein.

### BACKGROUND OF THE INVENTION

1. Field of the Invention

The invention relates to a computer image identification system and method, and in particular relates to a gender identification system for facial images and method thereof.

2. Description of the Related Art

Recently, an important field of computer vision has been facial image gender identification. Facial image gender identification systems are used in security systems, and for gender-oriented information dissemination, smart photography and analyzing the outcome of gender-oriented marketing. For example, when a gender identification system detects the gender of a person that is not permitted around a restroom or a dormitory, it can inform security guards or users with an alarm to prevent from crimes from occurring.

Conventional gender identification techniques usually identify a gender by human faces. It is a challenging problem to identify the gender on the ground of facial image gender identification because even humans are not able to identify gender 100 percent of the time. Due to variety of facial expressions or emotions of human faces, light changes, or incomplete visibility of human faces, the accuracy of prior works on gender identification is not good enough. Nevertheless, two key techniques have been disclosed which improve upon gender identification by capturing the characteristics of human faces and then comparing the captured characteristics with pre-built facial characteristics data.

Conventional algorithms for facial image gender identification perform face detection after capturing a facial image as the input image for a gender identification system. There are input image requirements for accuracy, such as having the direction of the face being toward the camera, no hat being worn, no facial expressions, a simple background, high image resolution, and uniform lighting etc. Nonetheless, commonly, input images may be blurry with low resolution, even with facial expressions and captured from various angles. Thus, it is not easy to compare the input images with the pre-built facial characteristics data to get a correct gender identification result. Accordingly, facial image gender identification algorithms which mitigate the above deficiencies are desired to increase identification accuracy and increase the speed of gender identification.

### BRIEF SUMMARY OF THE INVENTION

In view of this, a facial image gender identification method is provided in present invention. An exemplary embodiment of the facial image gender identification method comprises: receiving a facial image; calculating global feature values and local feature values of the facial image; and determining a gender identification result of the facial image according to the global feature values, the local feature values, and gender characteristic values and gender data corresponding to each of a plurality of training facial images respectively in a face database.

In another exemplary embodiment, the invention further provides a facial image gender identification system, comprising: a face database, for storing gender characteristic values and gender data corresponding to each of a plurality of training facial images respectively; an image capturing unit, for capturing at least one facial image; a gender identification data generating unit, coupled to the image capturing unit and the face database, for receiving the facial image from the image capturing unit and calculating global feature values and local feature values of the facial image; and a gender identification unit, coupled to the gender identification data generating unit and the face database, for determining a gender identification result from the facial image according to the global feature values and the local feature values from the gender identification data generating unit, and the gender characteristic values and gender data stored in the face database.

In yet another exemplary embodiment, the invention further provides a computer program product loaded into a machine to execute the facial image gender identification method of the invention, comprising: a first program code for receiving at least one facial image; a second program code for calculating global feature values and local feature values of the facial image; and a third program code for determining a gender identification result of the facial image according to the global feature values, the local feature values, and gender characteristic values and gender data corresponding to each of a plurality of training facial images stored in a face database respectively.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 illustrates the facial image gender identification system according to an embodiment of the invention;

FIG. 2 illustrates the flowchart of the facial image gender identification method during a training phase according to an embodiment of the invention;

FIG. 3 illustrates the flowchart of the facial image gender identification method during an identification phase according to an embodiment of the invention; and

FIG. 4 illustrates the flowchart of the facial image gender identification realtime system according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

In one embodiment of the invention, a facial image gender identification system is provided for determining the gender of facial images according to facial gender characteristic values and gender data corresponding to each of a plurality of training facial images stored in a face database. In some embodiments, the face database is built with a plurality of typical facial images with gender information as training data. First, basic adjustments are performed on a facial image. Further, face detection is performed to get a facial patch on the facial image and transform the facial image to a grayscale facial image. Accordingly, the facial patch among the grayscale facial image is divided into a global image and sub-images in order to calculate the global feature values and the local feature values of the facial image. Furthermore, the global feature values and the local feature values are normalized to obtain gender characteristic values. As a result, a gender model, which is built by analyzing the gender characteristic values, is stored in a face database. In some embodiments, training data in the face database can be enhanced by learning, training, or other real applications.

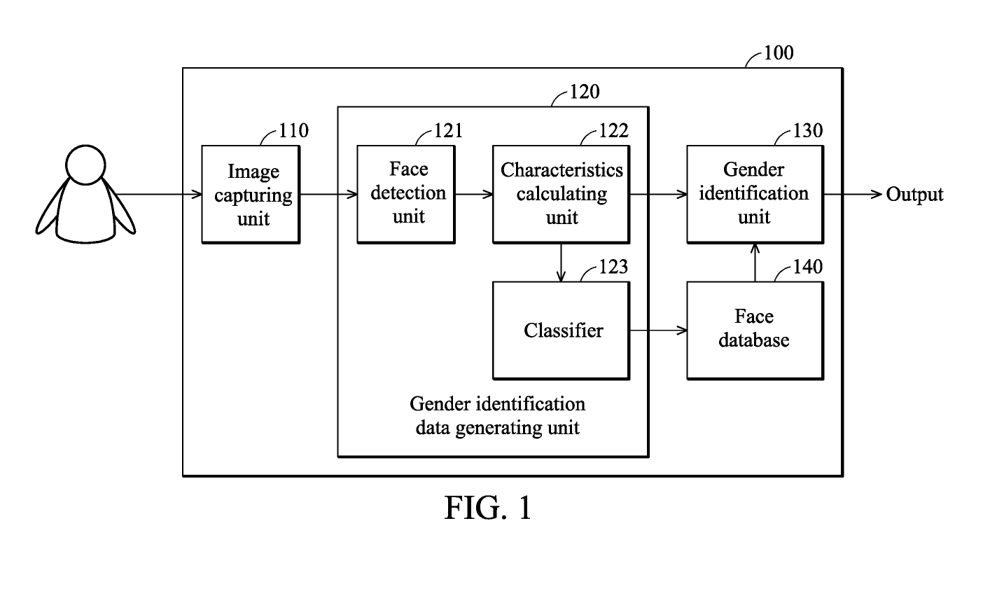

According to an embodiment in present invention, FIG. 1 illustrates the facial image gender identification system 100 according to an embodiment of the invention. The facial image gender identification system 100 can be employed in a mobile device or a computer device, such as mobile phone, PDA, GPS, laptop, and various types of computers, to perform gender identification for facial images. The facial image gender identification system 100 comprises at least an image capturing unit 110, a gender identification data generating unit 120, a gender identification unit 130 and a face database 140. The image capturing unit 110 is for receiving or detecting at least one facial image. For example, the image capturing unit 110 can be various types of video recorders, cameras, or other photographic equipment, which are capable of capturing facial images, or capturing a normal image and detecting the face on the normal image. In one embodiment, the image capturing unit 110 can also receive typical facial images with known genders as training data for training. The facial images from the image capturing unit 110 may have undesired features, such as facial expressions, poor rotation angles, blurriness, or low resolution. For poor rotation angles, some basic adjustments can be performed on the facial image. That is, the poor rotation angle of the face image can be adjusted out by rotating according to the center points of the located eye box.

The gender identification data generating unit 120, coupled to the image capturing unit 110 and the face database 140, is used for receiving the facial image from the image capturing unit 110, detecting the facial patches in the facial image and calculating the global feature values and local feature values of the facial patches. In other embodiments of present invention, the gender identification data generating unit 120 further normalizes the global feature values and the local feature values, and stores the normalized global feature values and local feature values and gender data into the face database 140.

In another embodiment, the gender identification data generating unit 120 further includes a face detection unit 121. For the face detection unit 121, the corresponding algorithms for detecting and retrieving the facial patches in video sequences or images are prior art, and thus implemented with a general algorithm. Meanwhile in another embodiment, Intel's OpenCV (open source computer vision) library is adapted to perform face detection and retrieve facial patches. The OpenCV library calculates the facial characteristics and retrieves the facial patches among the facial images by using Harr algorithm and Real Adaboost Cascade algorithm, which uses 20×20 pixels as the minimum range for detecting faces. However, the facial image detection method is not limited thereto. In one embodiment, the face detection unit 121 can further transform color images into grayscale images to reduce the effect of white balance.

In another embodiment, the gender identification data generating unit 120 further comprises a classifier 123 which is built according to the gender characteristic values and gender data corresponding to each of a plurality of training facial images stored in a face database. The gender identification unit 130 can determine the gender identification result from the facial image by the classifier 123, which can be a formula for gender classification, such as a support vector machine (SVM), but is not limited thereto. The classifier 123 can classify the normalized global feature values and local feature values into a gender model, and store the normalized global feature values and local feature values and the gender data into the face database 140.

In also another embodiment, the gender identification data generating unit 120 further includes a characteristics calculating unit 122 for calculating the characteristic values of the facial images. The face detection 121 transforms facial images into grayscale facial images and the transformation process can reduce the effect of white balance for calculating the characteristic values. Following is an equation for grayscale transformation:

I=0.212671*R+0.715160*G+0.072169*B

where I is the luminance value of a grayscale pixel; R is the brightness value of a red color; G is the brightness value of a green color; and B is the brightness value of blue color.

In another embodiment, the characteristics calculating unit 122 equally divides the detected facial patch in the grayscale facial image into one global image and 2×2, 3×3, 4×4 sub-images separately. In one embodiment, the solution of dividing image can be regarded as spatial pyramid. Then, six characteristic values of each image block are calculated, such as mean value, maximum value, minimum value, standard deviation value, x-gradient ratio and y-gradient ratio. The six characteristic values are calculated with the luminance pixels in the grayscale facial patch.

Following is an equation for calculating the mean value:

$$\overline{x} = \frac{1}{N} {\sum }_{i = 1}^{N} {x}_{i}$$

where X̅ is the mean value of luminance pixels; and N is the number of total pixels in the global image or the sub-images.

Following is an equation for calculating the standard deviation value:

$$σ = \sqrt{\frac{1}{N} {\sum }_{i = 1}^{N} {( {x}_{i} - \overline{x} )}^{2}}$$

where σ is the standard deviation value of luminance pixels; and N is the number of total pixels in the global image or the sub-images.

Following is an equation for calculating the x-gradient ratio:

$${Gx}_{i} = [ \begin{matrix}- 1 & 0 & + 1 \\ - 2 & 0 & + 2 \\ - 1 & 0 & + 1\end{matrix} ] * {A}_{i}$$

$${Rx}_{i} = \frac{{\sum }_{i = 1}^{N} {a}_{i}}{N}$$

$${a}_{i} = 1 when {Gx}_{i} > 0 , otherwise {a}_{i} = 0$$

where Rxᵢ is the x-gradient ratio; Gxᵢ is the horizontal gradient; N is the number of total pixels in the image block; Aᵢ is a 3×3 matrix with a center located in the calculated pixel in the global image. 2D plane convolution is performed by using a horizontal Sobel mask with the corresponding 3×3 matrix Aᵢ of each pixel in the global image to obtain the horizontal gradient for each pixel in the global image. The x-gradient ratio can be derived by dividing the total number of pixels in the global image with a horizontal gradient greater than zero, with the total number of pixels in the global image. The x-gradient ratio of each sub-image can be obtained in the same way as the global image.

Following is an equation for calculating the y-gradient ratio:

$${Gy}_{i} = [ \begin{matrix}+ 1 & + 2 & + 1 \\ 0 & 0 & 0 \\ - 1 & - 2 & - 1\end{matrix} ] * {A}_{i}$$

$${Ry}_{i} = \frac{{\sum }_{i = 1}^{N} {b}_{i}}{N}$$

$${b}_{i} = 1 when {Gy}_{i} > 0 , otherwise {b}_{i} = 0$$

where Ryᵢ is the y-gradient ratio; Gyᵢ is the horizontal gradient; N is the number of total pixels in the global image; Aᵢ is a 3×3 matrix with a center located in the calculated pixel of the global image. 2D convolution is performed using a vertical Sobel mask with the corresponding 3×3 matrix Aᵢ of each pixel in the global image to obtain the vertical gradient for each pixel in the global image. The y-gradient ratio can be derived by dividing the total number of pixels in the global image with vertical gradient greater than zero, with the total number of pixels in the global image. The y-gradient ratio of each sub-image can be obtained in the same way as the global image.

For example, each image block has its own six characteristic values which can be expressed as:

vₖ₋ᵢ=[ x̅,σ,max(x),min(x),Rₓ,R_{y}] (k=1˜4 i=1˜k²)

When the six characteristic values of each image block in the facial patch is calculated, a characteristics vector fᵢ of (1²+2²+3²+4²)*6=180 dimensions can be obtained by expanding all the characteristic values of each image block. The characteristics vectorfi can be expressed as:

fᵢ=[v₁₋₁,v₂₋₁,v₂₋₂,v₂₋₃,v₂₋₄,v₃₋₁,v₃₋₂, . . . , v₄₋₁₆]

Assigning numbers for each vector in the characteristics vector fᵢ can be expressed as:

fᵢ=[a₁,a₂,a₃, . . . , a₁₈₀]

If three thousand facial images are adapted as training data during a training phase, a characteristics matrix F with 180*3000 dimensions can be obtained which is expressed as:

$$F = [ \begin{matrix}{f}_{1} \\ {f}_{2} \\ {f}_{3} \\ ⋮ \\ {f}_{3000}\end{matrix} ] = [ \begin{matrix}{a}_{1 - 1} & {a}_{1 - 2} & {a}_{1 - 3} & … & {a}_{1 - 180} \\ {a}_{2 - 1} & {a}_{2 - 2} & {a}_{2 - 3} & … & {a}_{2 - 180} \\ {a}_{3 - 1} & {a}_{3 - 2} & {a}_{3 - 3} & … & {a}_{3 - 180} \\ ⋮ & ⋮ & ⋮ & ⋮ & ⋮ \\ {a}_{3000 - 1} & {a}_{3000 - 2} & {a}_{3000 - 3} & … & {a}_{3000 - 180}\end{matrix} ]$$

Then, the maximum value and minimum value of each column in characteristics matrix F can be calculated and the values of each column with the range of 0˜1 are normalized. For example, if the maximum value and minimum value of column 1 are M₁ and m₁, respectively, the normalized a₁₋₁ can be expressed as:

$${a}_{1 - 1}^{′} = \frac{{a}_{1 - 1 } - {m}_{1}}{{M}_{1} - {m}_{1}}$$

In the same way, each value of each column in the characteristics matrix F can be calculated to obtain an adjusted characteristics matrix Fₛ:

$${F}_{s} = [ \begin{matrix}{a}_{1 - 1}^{′} & {a}_{1 - 2}^{′} & {a}_{1 - 3}^{′} & … & {a}_{1 - 180}^{′} \\ {a}_{2 - 1}^{′} & {a}_{2 - 2}^{′} & {a}_{2 - 3}^{′} & … & {a}_{2 - 180}^{′} \\ {a}_{3 - 1}^{′} & {a}_{3 - 2}^{′} & {a}_{3 - 3}^{′} & … & {a}_{3 - 180}^{′} \\ ⋮ & ⋮ & ⋮ & ⋮ & ⋮ \\ {a}_{3000 - 1}^{′} & {a}_{3000 - 2}^{′} & {a}_{3000 - 3}^{′} & … & {a}_{3000 - 180}^{′}\end{matrix} ]$$

The adjusted characteristics matrix Fₛ and gender data is trained and classified by the classifier 123. The classifier 123 further stores the adjusted characteristics matrix Fₛ and gender data into the face database 140. In one embodiment, the adjusted characteristics matrix Fₛ includes normalized global feature values and local feature values, which are also regarded as gender characteristic values, corresponding to the global image and sub-images of the training facial images with a known gender respectively. The adjusted characteristics matrix Fₛ further determines a relationship formula for gender classification by using the classifier 123, which is a gender model stored in the face database 140.

In another embodiment of the present invention, the facial image gender identification system 100 further comprises a display unit (not shown) to display gender identification results of the facial images in the gender identification unit 130. For example, if the gender identification result of a facial image is male, the gender identification unit 130 will mark the male face with a blue label. If the gender identification result of a facial image is female, the gender identification unit 130 will mark the female face with a red label.

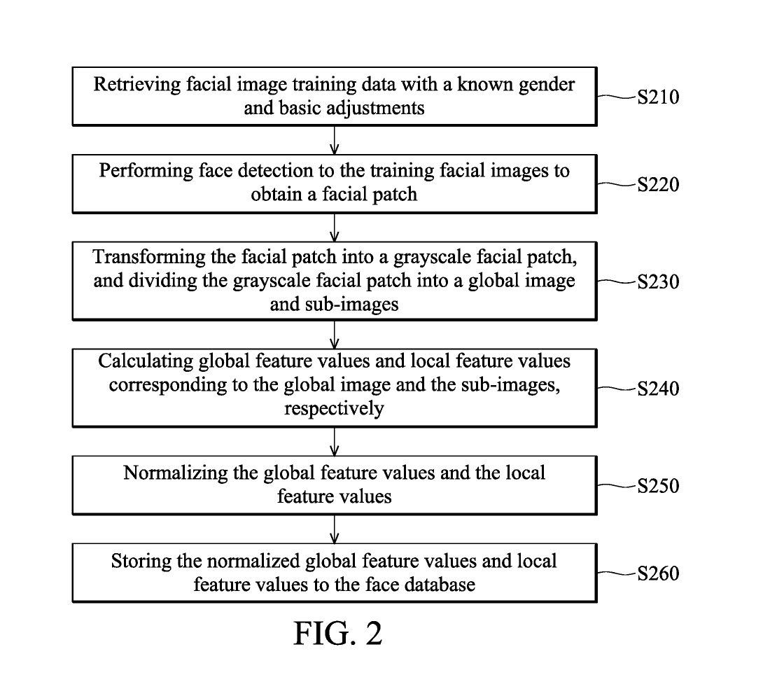

FIG. 2 illustrates the flowchart of the facial image gender identification method during a training phase according to an embodiment of the invention. The facial image gender identification method can be executed by the facial image gender identification system 100.

First, in step S210, the image capturing unit 110 retrieves training facial images of a known gender and basic adjustments. In step S220, the face detection unit 121 performs face detection on the training facial images to obtain facial patches. In step S230, the face detection unit 121 further transforms the facial patches into grayscale facial patches and the characteristics calculating unit 122 divides the grayscale facial patches into a global image and sub-images, respectively. In step S240, the characteristics calculating unit 122 calculates the global feature values and local feature values of the global image and sub-images, respectively. In step S250, the characteristics calculating unit 122 further normalizes the global feature values and local feature values of image blocks. In step S260, the classifier 123 stores the normalized global feature values and local feature values into the face database 140.

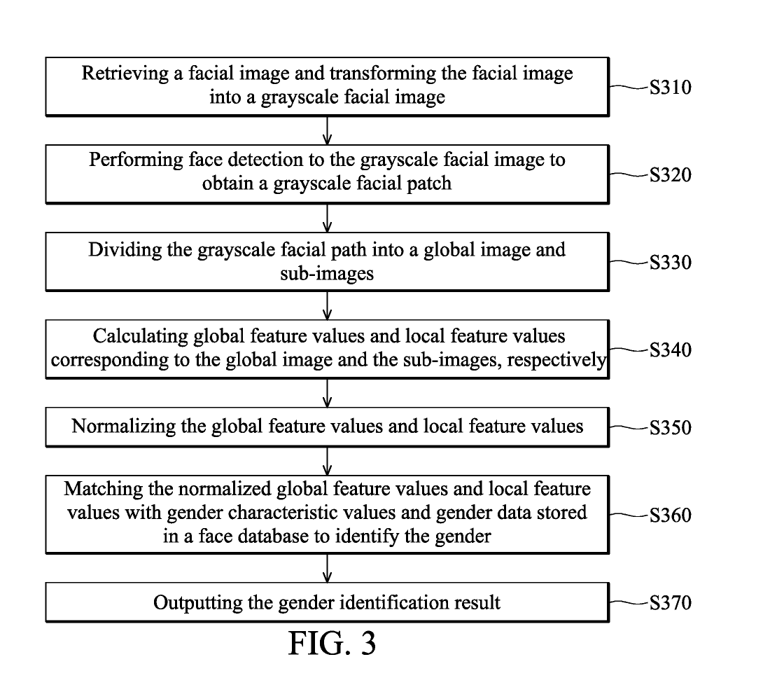

FIG. 3 illustrates the flowchart of the facial image gender identification method during an identification phase according to an embodiment of the invention. The facial image gender identification method can be executed by the facial image gender identification system 100.

First, in step S310, the image capturing unit 110 retrieves a facial image and the face detection unit transforms the facial image into a grayscale facial image. Further in step S320, the face detection unit performs face detection on the grayscale facial image to obtain grayscale facial patches. In step S330, the characteristics calculating unit 122 divides each grayscale facial patch into a global image and sub-images. In step S340, the characteristics calculating unit calculates the global feature values and local feature values of the global image and sub-images, respectively. In step S350, the characteristics calculating unit 122 further normalizes the global feature values and local feature values. In step S360, the gender identification unit 130 identifies gender by matching the normalized global feature values and local feature values with gender characteristic values and gender data stored in the face database 140. In step S370, the gender identification result is outputted.

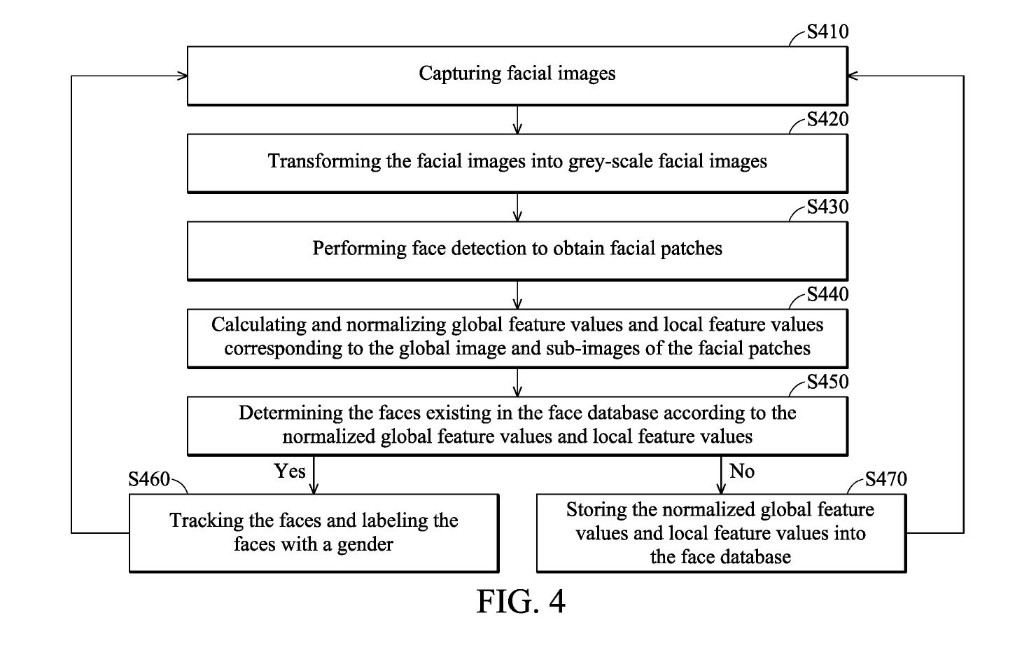

FIG. 4 illustrates the flowchart of the facial image gender identification realtime system according to an embodiment of the invention. First, in step S410, the image capturing unit 110, such as a web camera, continuously takes photos to obtain facial images. In step S420, the face detection unit 121 transforms the facial images into grayscale facial images for future steps. In step S430, the face detection unit 121 performs face detection on grayscale facial images to obtain facial patches. A facial image may contain multiple facial patches and is not limited to one facial patch. In step S440, the characteristics calculating unit 122 divides each facial patch into a global image and sub-images and calculates global feature values and local feature values of the global images and sub-images, respectively, which are subsequently normalized. In step S450, the gender identification unit 130 decides whether facial patches are stored in the face database 140 by matching the normalized global feature values and local feature values with the gender characteristic values and gender data stored in the face database 140. If facial patches exist in the face database 140, step S460 is performed. In step S460, the facial patches are traced and marked and then step S410 is performed to continuously capture facial images. If facial patches do not exist in the face database 140, step S470 is performed. In step S470, the gender identification unit 130 stores the global feature values and local feature values into the face database and then step S410 is performed to continuously capture facial images. In one embodiment, a time limitation can be set, for example, five minutes are allotted for storing global feature values and local feature values in the face database 140 of the facial image gender identification realtime system. When a person in front of a camera moves, the global feature values and local feature values of the face can be matched with data stored in the face database 140 to identify the gender of the person and mark the face with a label on the screen. When a different person enters the range of the camera or the original person leaves the range of the camera for more than five minutes, the global feature values and local feature values are re-calculated and then the gender of these faces are identified again according to the steps illustrated in FIG. 4.

In the aforementioned embodiments, the division of the sub-images is described a 2×2, 3×3 and 4×4 equally divided blocks; however, the present invention is not limited thereto. The division of the sub-images can be performed in other alternative ways. Also, the global feature values and local feature values are described with the six characteristic values of global images and sub-images, such as mean value, maximum value, minimum value, standard deviation value, x-gradient ratio, and y-gradient ratio; however, present invention is not limited thereto. Other characteristic values or some appropriate characteristic values chosen from the six characteristic values can be adapted.

The facial image gender identification system and method, or certain aspects or portions thereof, may take the form of program code embodied in tangible media, such as floppy diskettes, CD-ROMs, hard drives, or any other machine-readable (e.g., computer-readable) storage medium, or computer program products without limitation in external shape or form thereof, wherein, when the program code is loaded into and executed by a machine, such as a computer, the machine thereby becomes an apparatus for practicing the methods. The present invention also provides a computer program product for being loaded into a machine to execute a method for a facial image gender identification method, comprising: a first program code for receiving at least one facial image; a second program code for calculating global feature values and local feature values of the facial image; and a third program code for determining a gender identification result from the facial image according to the calculated global feature values, local feature values, and gender characteristic values and gender data corresponding to each of a plurality of training facial images stored in a face database.

The methods may also be embodied in the form of program code transmitted over some transmission medium, such as an electrical wire or a cable, or through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A facial image gender identification method, comprising
receiving a facial image;
calculating global feature values and local feature values of the facial image; and
determining a gender identification result of the facial image according to the global feature values, the local feature values, and gender characteristic values and gender data corresponding to each of a plurality of training facial images respectively in a face database.

2. The method as claimed in claim 1, further comprising:
transforming the facial image to a grayscale facial image; and
performing face detection on the grayscale facial image to obtain a grayscale facial patch, wherein the grayscale facial patch is divided into a global image and sub-images; and
calculating the global feature values and the local feature values according the global image and sub-images.

3. The method as claimed in claim 2, wherein the global feature values and the local feature values are corresponding to mean, maximum value, minimum value, standard deviation value, x-gradient ratio and y-gradient ratio of the global image and the sub-images respectively.

4. The method as claimed in claim 1, further comprising:
normalizing the global feature values and the local feature values, wherein the gender identification result is determined by using the normalized global feature values and local feature values.

5. The method as claimed in claim 1, wherein the gender characteristic values stored in the face database are derived by calculating the global feature values and the local feature values of each of the plurality of training facial images and normalizing the calculated global feature values and local feature values, and the gender identification result is determined by a classifier which is built according to the gender characteristic values and the gender data.

6. The method as claimed in claim 5, wherein the classifier determines a formula of gender classification and the formula is stored in the face database.

7. The method as claimed in claim 1, further comprising:
displaying and labeling a possible gender when the gender identification result of the facial image is determined.

8. The method as claimed in claim 7, wherein the male facial image and the female facial image are marked with a blue label and a red label respectively according to the gender identification result.

9. A facial image gender identification system, comprising:
a face database, for storing gender characteristic values and gender data corresponding to each of a plurality of training facial images respectively;
an image capturing unit, for capturing at least one facial image;
a gender identification data generating unit, coupled to the image capturing unit and the face database, for receiving the facial image from the image capturing unit and calculating global feature values and local feature values of the facial image; and
a gender identification unit, coupled to the gender identification data generating unit and the face database, for determining a gender identification result from the facial image according to the global feature values and the local feature values from the gender identification data generating unit, and the gender characteristic values and gender data stored in the face database.

10. The system as claimed in claim 9, wherein the gender identification data generating unit transforms the facial image to a grayscale facial image, divides the grayscale facial image into a global image and sub-images, and calculates the global feature values and local feature values according the global image and sub-images, respectively.

11. The system as claimed in claim 10, wherein the global feature values and local feature values are corresponding to mean value, maximum value, minimum value, standard deviation value, x-gradient ratio and y-gradient ratio of the global image and sub-images, respectively.

12. The system as claimed in claim 9, wherein the gender identification unit further normalizes the global feature values and local feature values and determines the gender identification result according to the normalized global feature values and local feature values.

13. The system as claimed in claim 9, wherein the gender characteristic values stored in the face database is obtained by using the image capturing unit and the gender identification data generating unit to calculate and normalize the global feature values and the local feature values of each of the plurality of training facial images, and the gender identification data generating unit further builds a classifier for the gender identification unit to determine the gender identification result by the classifier.

14. The system as claimed in claim 13, wherein the classifier determines a formula of gender identification and the formula is stored in the face database.

15. The system as claimed in claim 9, wherein the gender identification unit further displays the facial image and labels a possible gender of facial image on a display unit when the gender identification result of the facial image is determined.

16. The system as claimed in claim 15, wherein the male facial image and the female facial image are marked with a blue label and a red label respectively according to the gender identification result.

17. A computer program product for being loaded into a machine to execute a method for a facial image gender identification method, comprising:
a first program code for receiving at least one facial image;
a second program code for calculating global feature values and local feature values of the facial image; and
a third program code for determining a gender identification result of the facial image according to the global feature values, the local feature values, and gender characteristic values and gender data corresponding to each of a plurality of training facial images stored in a face database respectively.
